(19) United States
(12) Patent Application Publication
(10) Pub. No.: US 2026/0135434 A1
(43) Pub. Date: May 14, 2026

(54) BRUSHLESS HOLLOW CUP MOTOR

(71) Applicant: AAC MICROTECH (CHANGZHOU) CO., LTD., Changzhou (CN)

(72) Inventors: Jinguo Wu, Changzhou (CN); Sensen Yang, Changzhou (CN); Feng Yan, Changzhou (CN); Junsheng Wang, Changzhou (CN)

(21) Appl. No.: 19/324,186

(22) Filed: Sep. 10, 2025

Related U.S. Application Data
(63) Continuation of application No. PCT/CN2024/131609, filed on Nov. 12, 2024.

(51) Int. Cl. H02K 5/22; H02K 1/28; H02K 5/16; H02K 7/08; H02K 11/215; H02K 15/14; H02K 15/40

(52) U.S. Cl. CPC H02K 5/22; H02K 1/28; H02K 5/161; H02K 7/083; H02K 11/215; H02K 15/14; H02K 15/40; H02K 2211/03

(57) ABSTRACT

The present application provides a brushless hollow cup motor including a housing, a stator assembly fixed to the housing, a rotor assembly rotatably connected to the housing, a front cover and a bracket mounted on two ends of the housing, a circuit board fixed to the bracket, and an outlet terminal fixed to the circuit board. The stator assembly is provided around the rotor assembly. The front cover is engaged with the housing through a first limiting structure and fixedly welded to one end of the housing, the bracket is engaged with the housing through a second limiting structure and fixed to the other end of the housing, and the rotor assembly is rotatably connected to the front cover and the bracket. The brushless hollow cup motor has a simple structure, which facilitates ensuring an accurate and uniform position of the motor outlet, saves costs, and improves productivity.

### CROSS-REFERENCE TO RELATED APPLICATIONS

This application is a continuation of International Application No. PCT/CN 2024/131609, filed on Nov. 12, 2024, the entire contents of which are incorporated herein by reference.

### TECHNICAL FIELD

The present application relates to the field of motor technologies, in particular to a brushless hollow cup motor.

### BACKGROUND

Brushless hollow cup motors, characterized by their compact structure, high power density, high operational efficiency, and significant energy-saving benefits, have been widely applied in fields such as electric motors and generators. In recent years, the industrial sector has increasingly demanded equipment that uses brushless hollow cup motors to directly drive loads. The widespread application of these direct-drive devices powered by brushless hollow cup motors is expected to yield immeasurable energy-saving benefits.

In the related art, most of the traditional brushless hollow cup motors include a front cover, a rotor and a stator spaced around the rotor, and a bracket. The front cover and the bracket are provided at opposite ends of the stator, and the rotation of the motor is realized by mutual driving of the stator and the rotor. The stator includes a housing fixed to the front cover and a winding fixed in the housing, the rotor generally includes a rotor shaft and a magnet fixed to an outer peripheral side of the rotor shaft, and the motor rotation is realized by mutual driving of the magnet and the winding. However, in existing designs, the connection between the front cover, the bracket, and the housing relies on threaded connections. Threaded connections cannot accurately position the final relative alignment of the three components, and the limitations of this type of connection result in inconsistencies in the outlet position. Additionally, the use of extra clamps or jigs to assist in precisely adjusting the motor's outlet position affects the placement of the four mounting holes on the front cover. This ultimately renders the motor unfixable, leading to a poor user experience.

Therefore, it is necessary to provide a new brushless hollow cup motor to solve the above technical problems.

### SUMMARY

An object of the present application is to provide a brushless hollow cup motor with a simple structure, which facilitates ensuring an accurate and uniform position of the motor outlet, saves costs, and improves productivity.

In order to achieve the above object, the present application provides a brushless hollow cup motor including:
a housing;
a stator assembly fixed to the housing; and
a rotor assembly supported in the housing and rotatably connected to the housing, wherein the stator assembly is provided around the rotor assembly and spaced from the rotor assembly;
a front cover and a bracket mounted on two ends of the housing, respectively;
a circuit board fixed to a side of the bracket away from the housing; and
an outlet terminal fixed to a side of the circuit board away from the housing;
wherein the front cover is engaged with the housing through a first limiting structure and fixedly welded to one end of the housing, the bracket is engaged with the housing through a second limiting structure and press-fitted and fixed to the other end of the housing, and the rotor assembly is rotatably connected to the front cover and the bracket.

In an embodiment, the housing includes a hollow columnar housing body, an annular connecting portion formed by one end of the housing body extending radially inwardly, and a positioning hole formed through the connecting portion; the front cover includes a front cover body, an annular first tab formed by a protruding extension of a side of the front cover body close to the housing, a second tab formed by a protruding extension of a side of the first tab close to the housing, a positioning post formed by a protruding extension of the side of the first tab close to the housing, and a through-hole axially arranged through the second tab along an axial direction of the second tab; a side of the connecting portion close to the front cover is abutted against the first tab, an inner side of the connecting portion is sleeved on an outer periphery of the second tab, and the positioning post is inserted and fixed in the positioning hole; the positioning hole and the positioning post together form the first limiting structure; the stator assembly is fixed to an inner side wall of the housing body, and an end of the rotor assembly is inserted in the through hole and rotatably connected to the through hole.

In an embodiment, the housing further includes a plurality of limiting grooves formed by recessing the other end of the housing body along its axial direction, and limiting walls formed by a protruding extension of a side of each of the limiting grooves close to the bracket; the bracket includes a bracket body, a annular contact portion formed by a protruding extension of a side of the bracket body away from the housing, a limiting bump formed by protruding from an outer peripheral side of the bracket body, and an avoidance groove formed by recessing the outer peripheral side of the bracket body; the limiting bump and the avoidance groove are distributed along a circumferential direction of the bracket body, and the limiting bump is provided at a groove opening of the avoidance groove; the bracket body is inserted at an end of the housing body and fixed to an inner side wall of the housing body, a side of the contact portion close to the housing body is abutted against the housing body, and the limiting bump is provided in the limiting groove, and the limiting walls are provided in the avoidance groove; the limiting bump, the limiting grooves, the limiting walls, and the avoidance groove together form the second limiting structure, and the other end of the rotor assembly is supported on the bracket body and rotatably connected to the bracket body.

In an embodiment, the bracket further includes at least two third tabs formed by a protruding extension of a side of the bracket body away from the housing; the circuit board includes a circuit board body and at least two groove opening structures formed by recessed intervals in the circuit board body, wherein each of the third tabs is provided within one of the groove opening structures, respectively.

In an embodiment, the stator assembly includes a coil winding coaxially provided with the housing and fixed to the housing.

In an embodiment, the rotor assembly includes a rotor shaft rotatably connected to the front cover and the bracket, an iron core fixedly sleeved on the rotor shaft, and a permanent magnet fixedly sleeved on the iron core, wherein the permanent magnet is spaced apart from the stator assembly.

In an embodiment, the brushless hollow cup motor further includes a first bearing, which is fixedly sleeved on an end of the rotor shaft close to the front cover, wherein an outer periphery of the first bearing is fixed within the front cover.

In an embodiment, the brushless hollow cup motor further includes a second bearing, which is fixedly sleeved on an end of the rotor shaft away from the front cover, wherein an outer periphery of the second bearing is fixed within the bracket.

In an embodiment, the brushless hollow cup motor further includes a sensor assembly, which is configured to detect rotation data of the rotor shaft and includes a sensor magnet fixedly sleeved on an end of the rotor shaft away from the second bearing and a Hall sensor fixed to a side of the circuit board close to the bracket, wherein the Hall sensor is arranged opposite to and spaced from the sensor magnet.

In an embodiment, the brushless hollow cup motor further includes a protective cover, which is fixedly sleeved on the front cover and housing, wherein a side of the protective cover is provided with an avoidance space, and the outlet terminal on the circuit board is located within the avoidance space.

Compared with the related art, in the brushless hollow cup motor of the present application, the stator assembly is fixed in the housing, and the stator assembly is provided around the rotor assembly and spaced apart from the rotor assembly, so that the rotor assembly is rotatably connected to the housing. The brushless hollow cup motor further includes a front cover and a bracket mounted respectively at the two ends of the housing, a circuit board fixed to a side of the bracket away from the housing, and an outlet terminal fixed to a side of the circuit board away from the housing. The front cover is engaged with the housing through a first limiting structure and fixedly welded to one end of the housing, the bracket is engaged with the housing through a second limiting structure and press-fitted and fixed to the other end of the housing, and the rotor assembly is rotatably connected to the front cover and the bracket. By engaging the front cover with the housing through the first limiting structure and fixedly welding it to the housing, and by engaging the bracket with the housing through the second limiting structure and press-fitting it to the housing, the front cover, the housing, the bracket, and the circuit board collectively form an anti-misassembly feature chain at designated positions, which ensures the uniformity of the motor outlet position. Additionally, integrating these features into the components themselves simplifies the design of clamps and jigs, reduces their usage, indirectly lowers costs, and improves production efficiency.

### BRIEF DESCRIPTION OF THE DRAWINGS

In order to more clearly illustrate the technical solutions in the embodiments of the present application, the accompanying drawings that need to be used in the description of the embodiment will be briefly introduced as follows. Obviously, the accompanying drawings in the following description are only some of the embodiments of the present application, and for the person of ordinary skill in the field, other accompanying drawings may be obtained based on these drawings without putting forth any creative labor.

FIG. 1 is a schematic diagram of a three-dimensional structure of a brushless hollow cup motor according to an embodiment of the present application.

FIG. 2 is an exploded view of the three-dimensional structure of the brushless hollow cup motor according to an embodiment of the present application.

FIG. 3 is a sectional view of the brushless hollow cup motor in FIG. 1 along the line A-A;

FIG. 4 is a structural schematic diagram of a housing according to an embodiment of the present application.

FIG. 5 is a structural schematic diagram of a bracket according to an embodiment of the present application.

In the figures, 100, brushless hollow cup motor; 1, housing, 11, housing body; 12, connecting portion; 13, limiting groove; 14, limiting wall; 15, positioning hole; 2, stator assembly; 3, rotor assembly; 31, permanent magnet; 32, iron core; 33, rotor shaft; 4, front cover; 41, front cover body; 42, first tab; 43, second tab; 44, positioning post; 45, through hole; 5, bracket; 51, bracket body; 52, contact portion; 53, limiting bump; 54, avoidance groove; 55, third tab; 6, circuit board; 61, circuit board body; 62, groove opening structure; 7, outlet terminal; 8, first bearing; 9, second bearing; 10, sensor assembly; 101, sensor magnet; 102, Hall sensor; 20, protective cover; and 201, avoidance space.

### DETAILED DESCRIPTION OF THE EMBODIMENTS

The technical solutions in the embodiments of the present application will be described clearly and completely in the following in conjunction with the accompanying drawings in the embodiments of the present application. Obviously, the described embodiments are only a part of the embodiments of the present application and not all of the embodiments. Based on the embodiments in the present application, all other embodiments obtained by a person of ordinary skill in the art without making creative labor fall within the scope of protection of the present application.

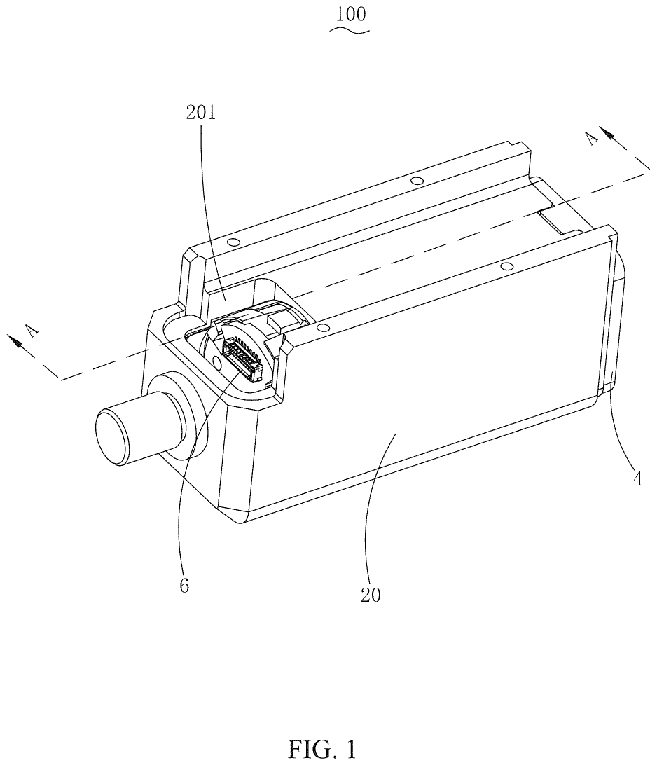

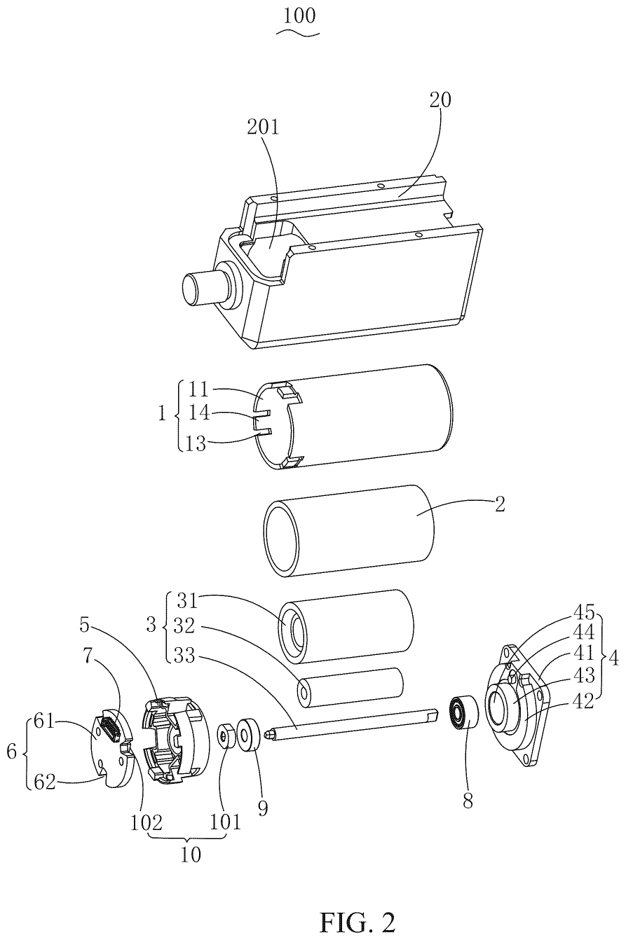

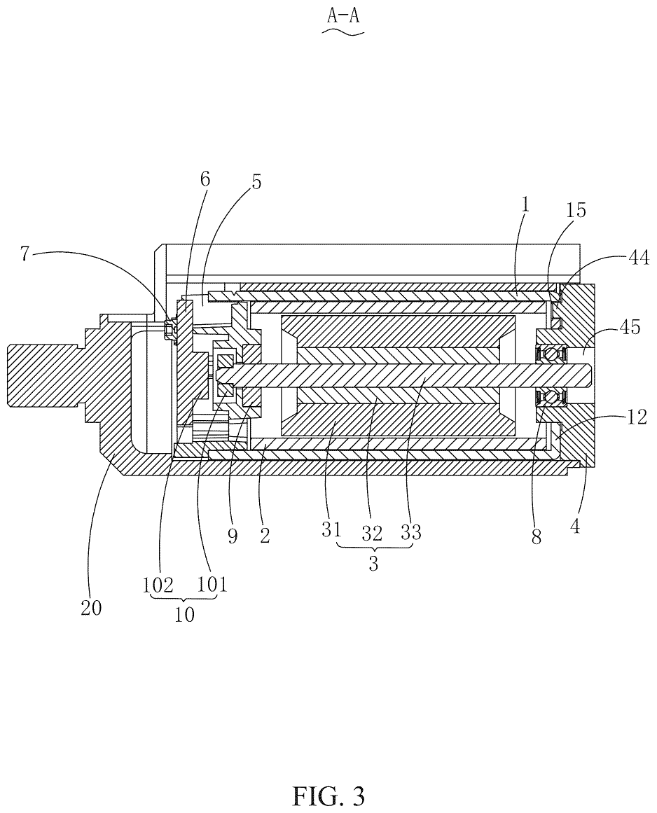

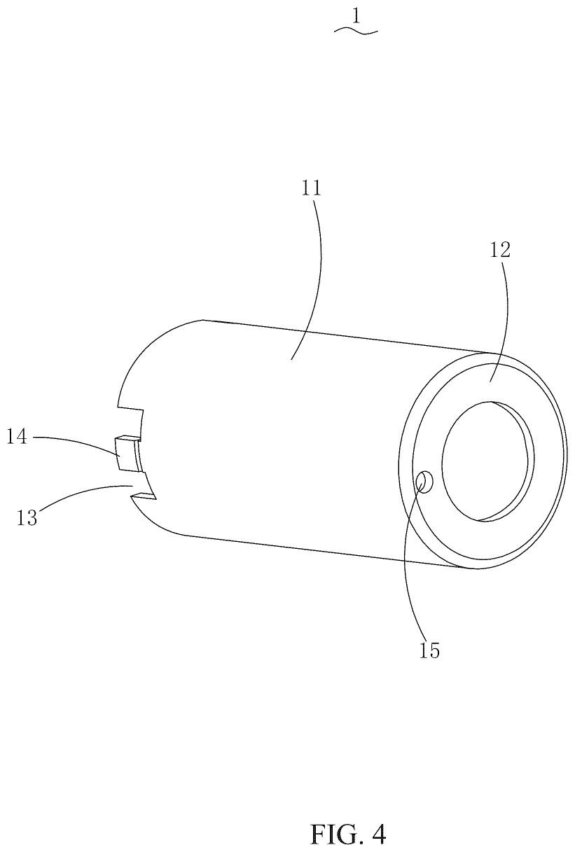

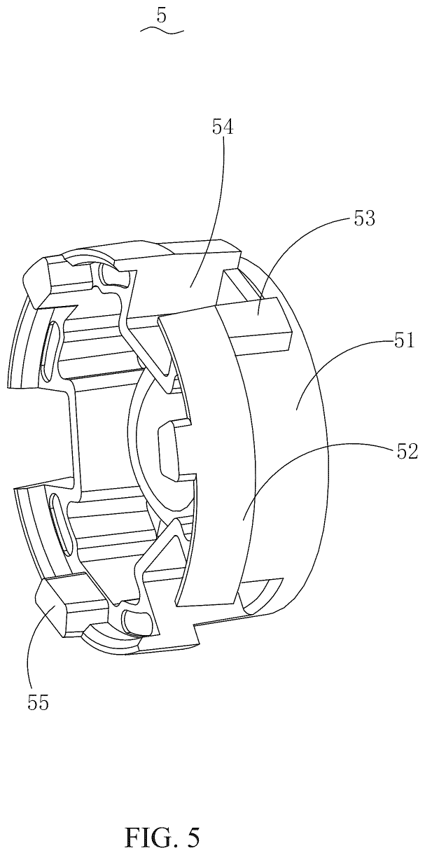

As shown in FIGS. 1 to 5, an embodiment of the present application provides a brushless hollow cup motor 100 including a housing 1, a stator assembly 2 fixed to the housing 1, and a rotor assembly 3 supported in the housing 1 and rotatably connected to the housing 1. The stator assembly 2 is provided around the rotor assembly 3 and spaced apart from the rotor assembly 3. The brushless hollow cup motor 100 further includes a front cover 4 and a bracket 5 mounted on two ends of the housing 1, respectively, a circuit board 6 fixed to a side of the bracket 5 away from the housing 1, and an outlet terminal 7 fixed to a side of the circuit board 6 away from the housing 1. The front cover 4 is engaged with the housing 1 through a first limiting structure and fixedly welded to one end of the housing 1. The bracket 5 is engaged with the housing 1 through a second limiting structure and press-fitted and fixed to the other end of the housing 1. The rotor assembly 3 is rotatably connected to the front cover 4 and the bracket 5.

The housing 1 is configured to fix the stator assembly 2 and support the rotation of the rotor assembly 3, and the stator assembly 2 and the rotor assembly 3 generate a mutual magnetic field to drive the rotor assembly 3 to rotate, thereby realizing the overall motor rotation.

Specifically, the stator assembly 2 is fixed in the housing 1, and the stator assembly 2 is provided around the rotor assembly 3 and spaced apart from the rotor assembly 3, so that the rotor assembly 3 is rotatably connected to the housing 1. The brushless hollow cup motor 100 further includes a front cover 4 and a bracket 5 mounted respectively at the two ends of the housing 1, a circuit board 6 fixed to a side of the bracket 5 away from the housing 1, and an outlet terminal 7 fixed to a side of the circuit board 6 away from the housing 1. The front cover 4 is engaged with the housing 1 through a first limiting structure and fixedly welded to one end of the housing 1, the bracket 5 is engaged with the housing 1 through a second limiting structure and press-fitted and fixed to the other end of the housing 1, and the rotor assembly 3 is rotatably connected to the front cover 4 and the bracket 5. By engaging the front cover 4 with the housing 1 through the first limiting structure and fixedly welding it to the housing 1, and by engaging the bracket 5 with the housing 1 through the second limiting structure and press-fitting it to the housing 1, the front cover 4, the housing 1, the bracket 5, and the circuit board 6 collectively form an anti-misassembly feature chain at designated positions, which ensures the uniformity of the outlet position of the outlet terminal 7 of the motor. Additionally, integrating these features into the components themselves simplifies the design of clamps and jigs, reduces their usage, indirectly lowers costs, and improves production efficiency.

In this embodiment, the housing 1 includes a housing body 11 in the form of a hollow column, an annular connecting portion 12 formed by one end of the housing body 11 extending inwardly along its radial direction, and a positioning hole 15 formed through the connecting portion 12.

In this embodiment, the front cover 4 includes a front cover body 41, an annular first tab 42 formed by a protruding extension of a side of the front cover body 41 close to the housing 1, a second tab 43 formed by a protruding extension of a side of the first tab 42 close to the housing 1, a positioning post 44 formed by a protruding extension of a side of the first tab 42 close to the housing 1, and a through-hole 45 axially arranged through the second tab 43 along an axial direction of the second tab 43. A side of the connecting portion 12 close to the front cover 4 is abutted against the first tab 42. An inner side of the connecting portion 12 is sleeved on the outer periphery of the second tab 43, and the positioning post 44 is inserted and fixed in the positioning hole 15. The positioning hole 15 and the positioning post 44 together form the first limiting structure. The stator assembly 2 is fixed to an inner side wall of the housing body 11, and the rotor assembly 3 is provided in the through-hole 45 and forms a rotational connection. By abutting the first tab 42 of the front cover 4 against the end face of the housing 1, setting the second tab 43 inside the housing 1, and inserting the positioning post 44 inside the positioning hole 15, the positioning post 44 and the positioning hole 15 form an anti-misassembly fit setting, thereby making the assembly between the front cover 4 and the housing 1 convenient.

In this embodiment, the housing 1 further includes a plurality of limiting grooves 13 formed by recessing the other end of the housing body 11 along its axial direction, and limiting walls 14 formed by a protruding extension of a side of each limiting groove 13 close to the bracket 5. The front cover 4 is fixed to the connecting portion 12, the stator assembly 2 is fixed to the inner side wall of the housing body 11, and the bracket 5 is set on the other end of the housing body 11 and is snap-fitted with the front cover 4. The housing body 11 is configured to fix and mount the stator assembly 2, and the connecting portion 12 is welded to the front cover 4, so that the front cover 4 and the housing 1 are well fixed as a whole. The limiting grooves 13, the limiting walls 14, and the bracket 5 form an anti-misassembly feature chain, thereby ensuring that the motor outlet position is accurate and uniform.

In this embodiment, the bracket 5 includes a bracket body 51, an annular contact portion 52 formed by a protruding extension of a side of the bracket body 51 away from the housing 1, a limiting bump 53 formed by protruding from an outer peripheral side of the bracket body 51, and an avoidance groove 54 formed by recessing the outer peripheral side of the bracket body 51. The limiting bump 53 and the avoidance groove 54 are distributed along a circumferential direction of the bracket body 51, and the limiting bump 53 is provided at a groove opening of the avoidance groove 54. The bracket body 51 is inserted at one end of the housing body 11 and fixed to the inner side wall of the housing body 11. A side of the contact portion 52 close to the housing body 11 is abutted against the housing body 11, the limiting bump 53 is provided in the limiting groove 13, and the limiting walls 14 are provided within the avoidance groove 54. The limiting bump 53, the limiting groove 13, the limiting wall 14, and the avoidance groove 54 together form the second limiting structure, and the other end of the rotor assembly 3 is supported on the bracket body 51 and rotatably connected to the bracket body 51. By setting the limiting wall 14 in the avoidance groove 54, the limiting bump 53 is made to snap into the limiting groove 13, realizing the anti-misassembly design of the limiting groove 13 to the limiting bump 53, and designing the anti-misassembly features of the limiting groove 13 and the limiting bump 53 at specific positions to form an anti-misassembly feature chain, which together realize the uniformity of the motor outlet position.

In an embodiment, the limiting bumps 53 are limiting blocks or limiting posts, etc.

In this embodiment, the bracket 5 further includes at least two third tabs 55 formed by a protruding extension of a side of the bracket body 51 away from the housing 1. The circuit board 6 includes a circuit board body 61 and at least two groove opening structures 62 formed by recessed intervals in the circuit board body 61. Each of the third tabs 55 is provided within one of the groove opening structures 62, respectively. The third tabs 55 and the groove opening structures 62 form an anti-misassembly chain setting with each other, ensuring effective mutual positioning between the bracket 5 and the circuit board 6. This facilitates alignment of the outlet position of the outlet terminal 7 with the direction of the front cover 4 and the limiting protrusion 53, collectively achieving uniformity in the motor wire outlet position.

In this embodiment, the stator assembly 2 is a coil winding coaxially provided with the housing 1 and fixed to the housing 1. The coil winding and the rotor assembly 3 mutually generate a magnetic field to drive the rotor assembly 3 to rotate.

In this embodiment, the rotor assembly 3 includes a rotor shaft 33 rotatably connected to the front cover 4 and the bracket 5, an iron core 32 fixedly sleeved on the rotor shaft 33, and a permanent magnet 31 fixedly sleeved on the iron core 32. The permanent magnet 31 is spaced apart from the stator assembly 2. The stator assembly 2 interacts with the permanent magnets 31 to generate a magnetic field that drives the rotor shaft 33 to rotate between the front cover 4 and the bracket 5, thereby realizing the motor rotation effect.

In this embodiment, the brushless hollow cup motor 100 further includes a first bearing 8, which is fixedly sleeved on an end of the rotor shaft 33 close to the front cover 4, and an outer periphery of the first bearing 8 is fixed inside the front cover 4. The first bearing 8 reduces the friction between the rotor shaft 33 and the front cover 4 and improves the rotational efficiency of the rotor shaft 33.

In this embodiment, the brushless hollow cup motor 100 further includes a second bearing 9, which is fixedly sleeved on an end of the rotor shaft 33 away from the front cover 4. The outer periphery of the second bearing 9 is fixed within the bracket 5. The second bearing 9 supports the rotor shaft 33 to be set within the bracket 5, resulting in good rotational stability of both ends of the rotor shaft 33.

In this embodiment, the brushless hollow cup motor 100 further includes a sensor assembly 10, which is configured to detect the rotation data of the rotor shaft 33. The sensor assembly 10 includes a sensor magnet 101 fixedly sleeved on an end of the rotor shaft 33 away from the second bearing 9 and a Hall sensor 102 fixed to a side of the circuit board 6 close to the bracket 5. The Hall sensor 102 is arranged opposite to and spaced from the sensor magnet 101. The rotation data of the rotor shaft 33 is collected by the sensor magnet 101, the signal transmission is carried out by the sensor magnet 101 and the Hall sensor 102 to each other, the processing of the rotation data is carried out by the Hall sensor 102, and the processed data is transmitted to an external device for display.

In this embodiment, the brushless hollow cup motor 100 further includes a protective cover 20, which is fixedly sleeved on the front cover 4 and housing 1. A side of the protective cover 20 is provided with an avoidance position 201, and the outlet terminal 7 on the circuit board 6 is located within the avoidance position 201, facilitating the outlet terminal 7 to exit the wire.

Compared with the related art, in the brushless hollow cup motor of the present application, the stator assembly is fixed in the housing, and the stator assembly is provided around the rotor assembly and spaced apart from the rotor assembly, so that the rotor assembly is rotatably connected to the housing. The brushless hollow cup motor further includes a front cover and a bracket mounted respectively at the two ends of the housing, a circuit board fixed to a side of the bracket away from the housing, and an outlet terminal fixed to a side of the circuit board away from the housing. The front cover is engaged with the housing through a first limiting structure and fixedly welded to one end of the housing, the bracket is engaged with the housing through a second limiting structure and press-fitted and fixed to the other end of the housing, and the rotor assembly is rotatably connected to the front cover and the bracket. By engaging the front cover with the housing through the first limiting structure and fixedly welding it to the housing, and by engaging the bracket with the housing through the second limiting structure and press-fitting it to the housing, the front cover, the housing, the bracket, and the circuit board collectively form an anti-misassembly feature chain at designated positions, which ensures the uniformity of the motor outlet position. Additionally, integrating these features into the components themselves simplifies the design of clamps and jigs, reduces their usage, indirectly lowers costs, and improves production efficiency.

Described above are only embodiments of the present application, and it should be pointed out that, for the ordinary technical personnel in the field, improvements may also be made without departing from the premise of the concept of the present application, but these are all within the protection scope of the present application.

What is claimed is:

1. A brushless hollow cup motor, comprising:
a housing;
a stator assembly fixed to the housing; and
a rotor assembly supported in the housing and rotatably connected to the housing, wherein the stator assembly is provided around the rotor assembly and spaced from the rotor assembly;
a front cover and a bracket mounted on two ends of the housing, respectively;
a circuit board fixed to a side of the bracket away from the housing; and
an outlet terminal fixed to a side of the circuit board away from the housing;
wherein the front cover is engaged with the housing through a first limiting structure and fixedly welded to one end of the housing, the bracket is engaged with the housing through a second limiting structure and press-fitted and fixed to the other end of the housing, and the rotor assembly is rotatably connected to the front cover and the bracket.

2. The brushless hollow cup motor of claim 1, wherein the housing comprises a hollow columnar housing body, an annular connecting portion formed by one end of the housing body extending radially inwardly, and a positioning hole formed through the connecting portion; the front cover comprises a front cover body, an annular first tab formed by a protruding extension of a side of the front cover body close to the housing, a second tab formed by a protruding extension of a side of the first tab close to the housing, a positioning post formed by a protruding extension of the side of the first tab close to the housing, and a through-hole axially arranged through the second tab along an axial direction of the second tab; a side of the connecting portion close to the front cover is abutted against the first tab, an inner side of the connecting portion is sleeved on an outer periphery of the second tab, and the positioning post is inserted and fixed in the positioning hole; the positioning hole and the positioning post together form the first limiting structure; the stator assembly is fixed to an inner side wall of the housing body, and an end of the rotor assembly is inserted in the through hole and rotatably connected to the through hole.

3. The brushless hollow cup motor of claim 2, wherein the housing further comprises a plurality of limiting grooves formed by recessing the other end of the housing body along its axial direction, and limiting walls formed by a protruding extension of a side of each of the limiting grooves close to the bracket; the bracket comprises a bracket body, a annular contact portion formed by a protruding extension of a side of the bracket body away from the housing, a limiting bump formed by protruding from an outer peripheral side of the bracket body, and an avoidance groove formed by recessing the outer peripheral side of the bracket body; the limiting bump and the avoidance groove are distributed along a circumferential direction of the bracket body, and the limiting bump is provided at a groove opening of the avoidance groove; the bracket body is inserted at an end of the housing body and fixed to an inner side wall of the housing body, a side of the contact portion close to the housing body is abutted against the housing body, the limiting bump is provided in the limiting groove, and the limiting walls are provided in the avoidance groove; the limiting bump, the limiting grooves, the limiting walls, and the avoidance groove together form the second limiting structure, and the other end of the rotor assembly is supported on the bracket body and rotatably connected to the bracket body.

4. The brushless hollow cup motor of claim 3, wherein the bracket further comprises at least two third tabs formed by a protruding extension of a side of the bracket body away from the housing; the circuit board comprises a circuit board body and at least two groove opening structures formed by recessed intervals in the circuit board body, wherein each of the third tabs is provided within one of the groove opening structures, respectively.

5. The brushless hollow cup motor of claim 1, wherein the stator assembly comprises a coil winding coaxially provided with the housing and fixed to the housing.

6. The brushless hollow cup motor of claim 1, wherein the rotor assembly comprises a rotor shaft rotatably connected to the front cover and the bracket, an iron core fixedly sleeved on the rotor shaft, and a permanent magnet fixedly sleeved on the iron core, wherein the permanent magnet is spaced apart from the stator assembly.

7. The brushless hollow cup motor of claim 6, further comprising a first bearing, which is fixedly sleeved on an end of the rotor shaft close to the front cover, wherein an outer periphery of the first bearing is fixed within the front cover.

8. The brushless hollow cup motor of claim 6, further comprising a second bearing, which is fixedly sleeved on an end of the rotor shaft away from the front cover, wherein an outer periphery of the second bearing is fixed within the bracket.

9. The brushless hollow cup motor of claim 6, further comprising a sensor assembly, which is configured to detect rotation data of the rotor shaft and comprises a sensor magnet fixedly sleeved on an end of the rotor shaft away from the second bearing and a Hall sensor fixed to a side of the circuit board close to the bracket, wherein the Hall sensor is arranged opposite to and spaced from the sensor magnet.

10. The brushless hollow cup motor of claim 1, further comprising a protective cover, which is fixedly sleeved on the front cover and housing, wherein a side of the protective cover is provided with an avoidance space, and the outlet terminal on the circuit board is located within the avoidance space.
